(19) United States
(12) Patent Application Publication
(10) Pub. No.: US 2018/0154502 A1
(43) Pub. Date: Jun. 7, 2018

(54) METHOD FOR MAKING A DUST-PROOF RATCHET WRENCH

(71) Applicant: Chia-Ke HUNG, Taichung City (TW)

(72) Inventor: Chia-Ke HUNG, Taichung City (TW)

(21) Appl. No.: 15/886,624

(22) Filed: Feb. 1, 2018

Related U.S. Application Data
(62) Division of application No. 14/789,063, filed on Jul. 1, 2015.

(51) Int. Cl. B25B 13/46; B25B 23/00

(52) U.S. Cl. CPC B25B 13/463; B25B 23/0007

(57) ABSTRACT

A method for making a dust-proof ratchet wrench includes the following steps of: previously formed an embryo of the dust-proof ring, wherein the POM is previously formed a tube-shaped embryo of the dust-proof ring by injection molding; processing a shank of the dust-proof ratchet, wherein a through hole is defined in one end of the shank, a series of teeth is formed on the inner periphery of the through hole and two annular grooves are respectively defined in two opposite sides of the shank; finishing the dust-proof ring, wherein the tube-shaped embryo of the dust-proof ring is cut to form a ring structure according to the diameter of the annular groove and the diameter of the tool for processing the annular groove; and assembling, wherein each annular groove has a dust-proof ring mounted therein, a switch, a direction select device and a drive device sequentially mounted onto the shank.

### CROSS-REFERENCE TO RELATED U.S. APPLICATIONS

The present application is a division of U.S. application Ser. No. 14/789,063, filed on Jul. 1, 2015, and entitled “Dust-proof Ratchet Wrench and Method for Making the Same”, presently pending.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention relates to a method, and more particularly to a method for making a dust-proof ratchet wrench.

2. Description of Related Art Including Information Disclosed Under 37 CFR 1.97 and 37 CFR 1.98.

A ratchet wrench is widely used for tightening or loosening a bolt/nut because the ratchet wrench can be reciprocally continually operated when tightening or loosening a bolt/nut. Consequently, the ratchet wrench is a convenient tool. As generally known, the ratchet wrench is used in mechanical scope. However, the ratchet wrench sometimes is an indispensable tool, as for screwing a pinning into a bone of a fracture injury or screwing a base for tooth implant such that the ratchet wrench must have the function of dust-proof when being used in medical scope.

The conventional ratchet wrench uses O-ring to achieve the objective of dust-proof, wherein the conventional ratchet has two O-rings respectively clamped on two opposite sides of a shank thereof. However, the O-rings are mode of rubber and provide a great friction force when the shank is reversely operated. The friction force causes a great reaction that directly influences a normal operation of the conventional dust-proof ratchet wrench. Moreover, the O-ring may be broken and loses the function of dust-proof.

Furthermore, the O-ring for the conventional dust-proof ratchet wrench is marketed standard product and the annular groove for receiving the O-ring is processed by lathe. The O-ring may not be assembled into the annular groove when any one of the processes for molding the O-ring and the process for defining the annular groove. The loss is not just money, but the goodwill of the manufacturer.

The present invention has arisen to mitigate and/or obviate the disadvantages of the conventional dust-proof ratchet wrench.

### BRIEF SUMMARY OF THE INVENTION

The main objective of the present invention is to provide an improved method for making a ratchet wrench that has a dust-proof function.

To achieve the objective, the method in accordance with the present invention comprises the following steps of: previously formed an embryo of the dust-proof ring, wherein the POM is previously formed a tube-shaped embryo of the dust-proof ring by injection molding; processing the shank of the dust-proof ratchet, wherein a through hole is defined in one end of the shank, a series of teeth is formed on the inner periphery of the through hole and two annular grooves are respectively defined in two opposite sides of the shank, the two annular grooves respectively co-axially corresponding to the through hole and the width of the tube-shaped embryo of the dust-proof ring being equal to a diameter of a tool for processing the annular groove; finishing the dust-proof ring, wherein the tube-shaped embryo of the dust-proof ring is cut to form a ring structure according to the diameter of the annular groove and the diameter of the tool for processing the annular groove, the finished dust-proof ring having a thickness slight greater than a depth of the annular groove; and assembling, wherein each annular groove has a dust-proof ring mounted therein, a switch, a direction select device and a drive device sequentially mounted onto the shank, wherein a stub, extending from the drive device, is rotatably engaged into a hole defined in the switch to make a first tray of the drive device and a second tray of the switch respective abut against a corresponding one of the two dust-proof ring.

Further benefits and advantages of the present invention will become apparent after a careful reading of the detailed description with appropriate reference to the accompanying drawings.

### BRIEF DESCRIPTION OF THE SEVERAL VIEWS OF THE DRAWINGS

FIG. 1 is a partially perspective view of a dust-proof ratchet wrench in accordance with the present invention.

FIG. 2 is an exploded perspective view of the dust-proof ratchet wrench in accordance with the present invention.

FIG. 3 is a side exploded plan view of the dust-proof ratchet wrench in accordance with the present invention.

FIG. 4 is a side cross-sectional view of the dust-proof ratchet wrench in accordance with the present invention.

FIG. 5 is a partially enlarged view of FIG. 4.

FIG. 6 is another partially enlarged view of FIG. 4.

### DETAILED DESCRIPTION OF THE INVENTION

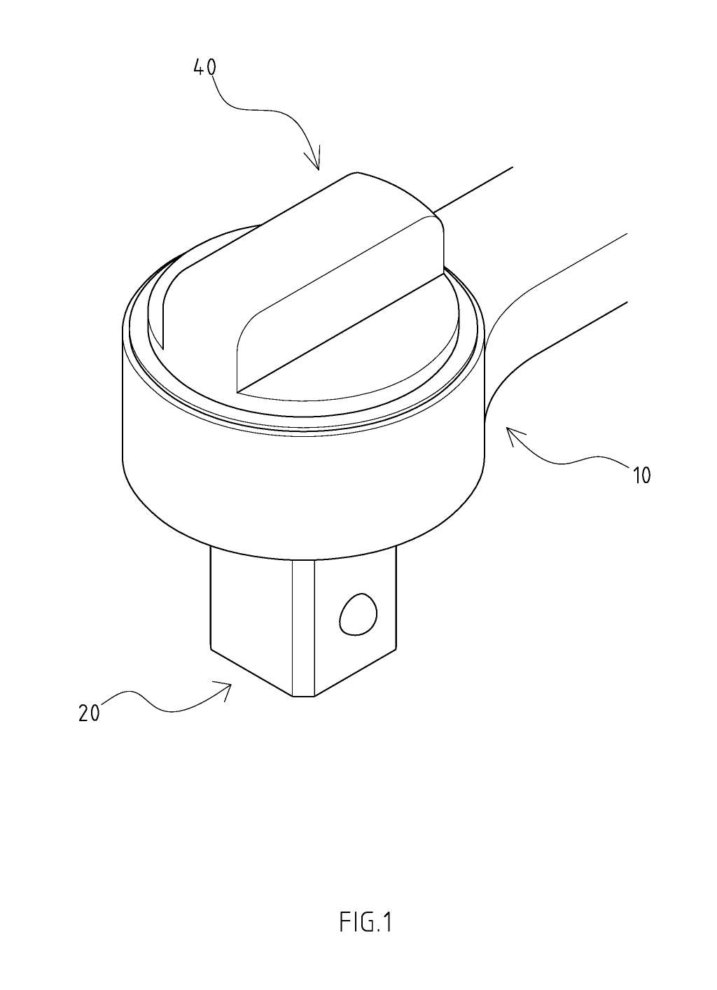

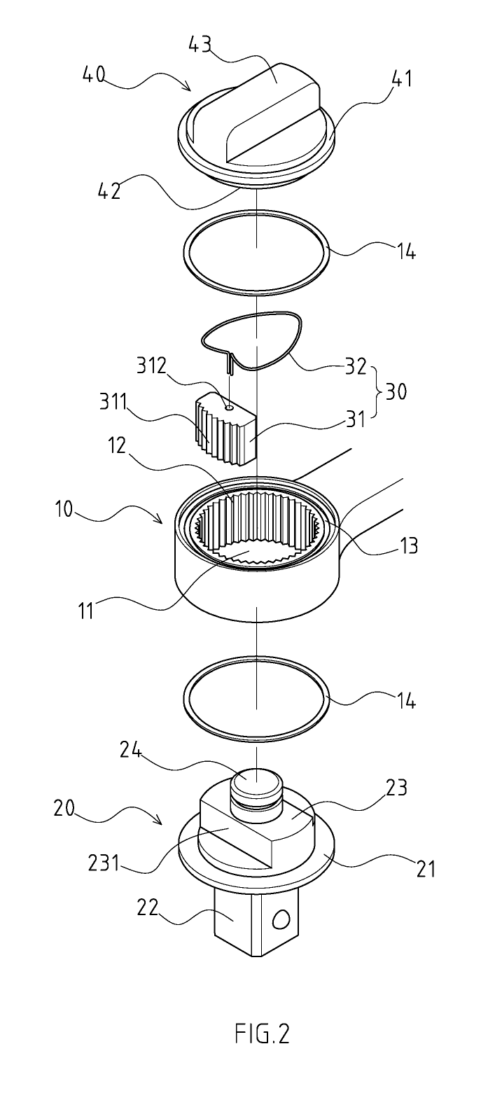

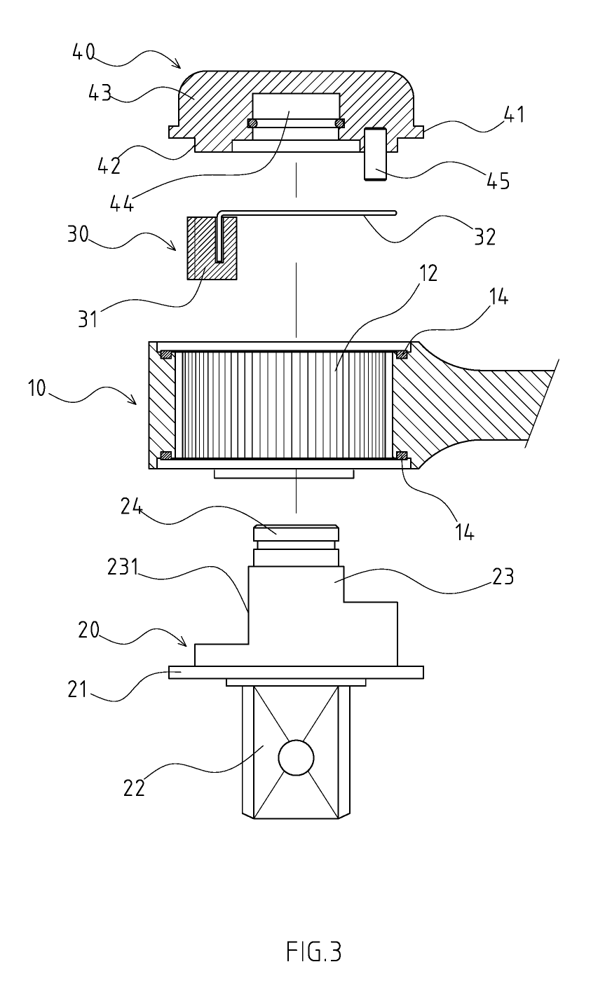

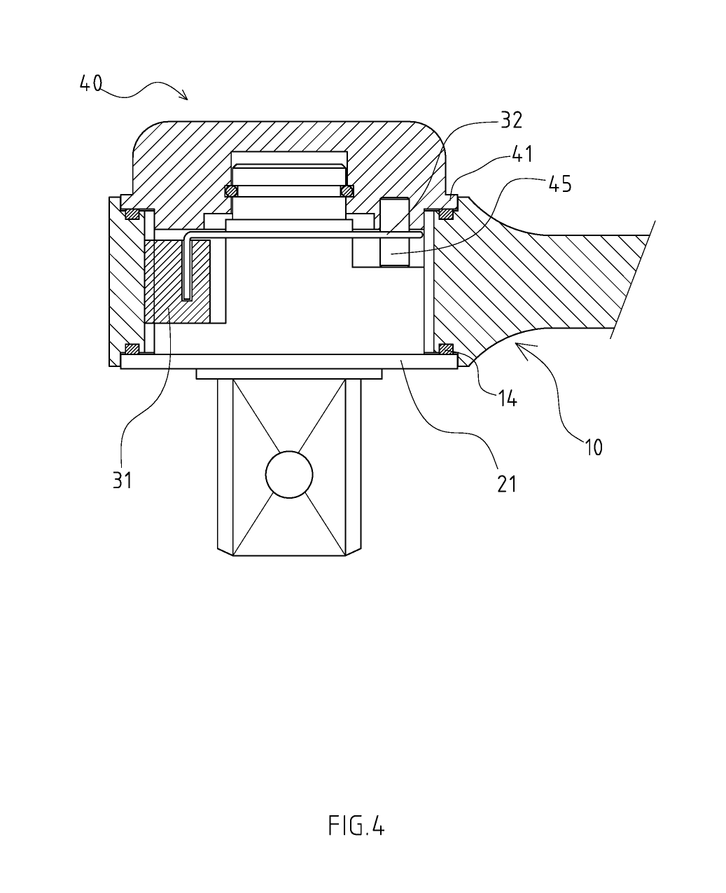

Referring to the drawings and initially to FIGS. 1-4, a dust-proof ratchet wrench in accordance with the present invention comprises a shank 10, a drive device 20 partially received in one end of the shank 10, a direction select device 30 received in the shank 10 and a switch 40 rotatably mounted on one end of the shank 10 for driving the direction select device 30 to change the operating direction of the ratchet wrench.

The shank 10 has a through hole 11 defined in one end thereof. A series of teeth 12 is formed on the inner periphery of the through hole 11. The shank 10 has two opposite sides respectively having an annular groove 13 defined therein, wherein the two annular grooves 13 respectively co-axially correspond to the through hole 11 and a dust-proof ring 14 is received in a corresponding one of the two annular grooves 13. In the preferred embodiment of the present invention, the cross-section of the dust-proof ring 14 is rectangle and each dust-proof ring 14 has a thickness greater than a depth of each of the two annular grooves 13. The dust-proof ring 14 is made of POM (polyoxymethylene). The POM has the following material properties including high rigidity, low friction and having dimension stability.

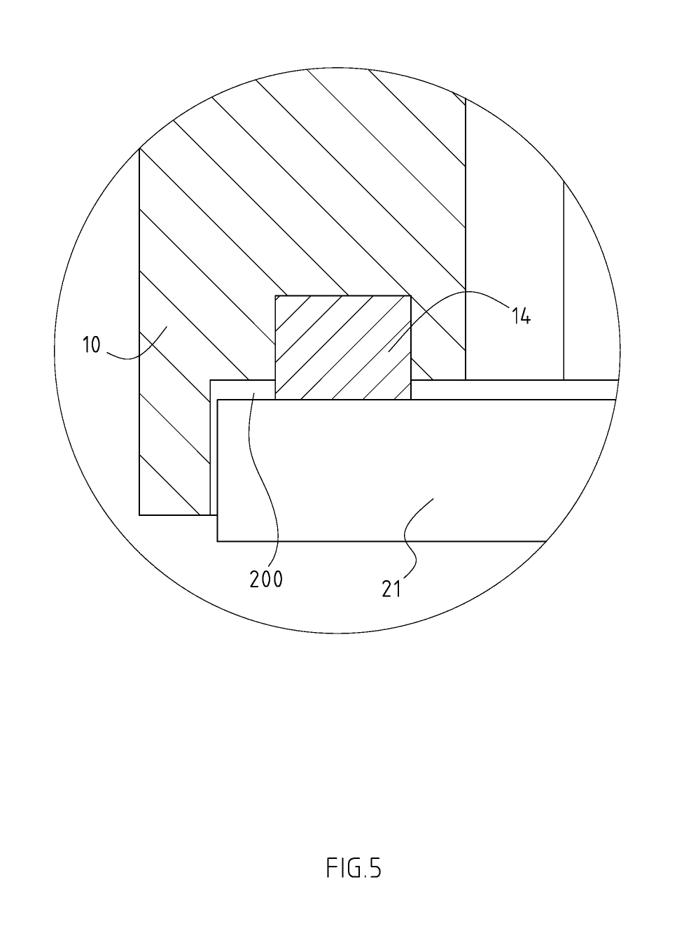

With reference to FIG. 5, the drive device 20 includes a first tray 21 rotatably abutting against a corresponding one of the two dust-proof rings 14 and having a diameter greater than that of the corresponding dust-proof ring 14. A first gap 200 is formed between the first tray 21 and the shank 10 because the dust-proof ring 14 has a thickness greater than a depth of each of the two annular grooves 13. The firs tray 21 includes two opposite faces respectively having a polygonal stub 22 and an abutment 23 respectively centrally extending therefrom, wherein the abutment 23 is received in the through hole 11 and formed with a vertical side 231. In preferred embodiment of the present invention, the polygonal stub 22 is a quartet and adapted to be connected to a socket (not shown) for driving a bolt/nut. The abutment 23 has a stub 24 vertically extending therefrom along an axis of the drive device 20 for being co-axially assembled to the switch 40.

The direction select device 30 includes an engager 31 received in the through hole 11 between the vertical side 231 and the inner periphery of the through hole 11. The engager 31 has one side, facing the series of teeth 12, having a series of ratchets 311 formed thereon. The operating direction of drive device 20 is decided by the series of teeth 12 and the series of ratchets 311. The engager 31 has a bore 312 defined in a top thereof, wherein a resilient member 32 is mounted into the bore 312, and backward and horizontally extends relative to the shank 10.

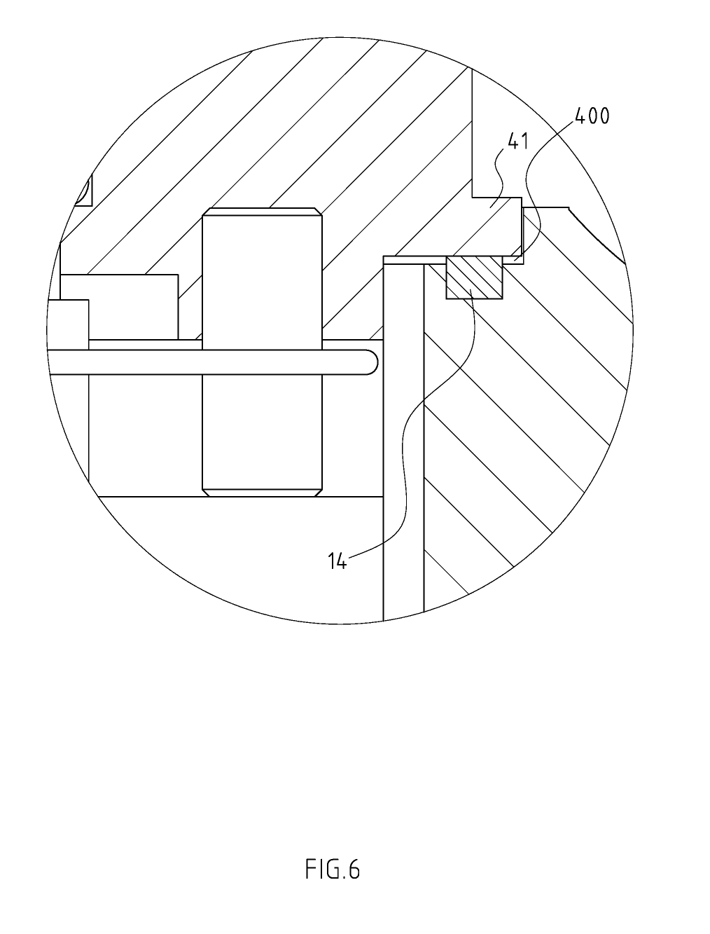

Further with reference to FIG. 6, the switch 40 is mounted onto the drive device 20. The switch includes a second tray 41 rotatably abutting against a corresponding one of the two dust-proof rings 14 and having a diameter greater than that of the corresponding dust-proof ring 14. A second gap 400 is formed between the second tray 41 and the shank 10 because the dust-proof ring 14 has a thickness greater than a depth of each of the two annular grooves 13. A protrusion 42 and a platform 43 respectively extend from two opposite sides of the second tray 41, wherein the protrusion 42 is received in the through hole 11 and has a hole centrally defined to receive the stub 24. A rod 45 is securely inserted into the protrusion 42 and connected to the resilient member 32 such that the engaging direction of the engager 31 and the operating direction of the drive device 20 are changed when the switch 40 is reciprocally rotated relative to the shank 10 by using the platform 43.

With regard to operation of the ratchet wrench in accordance with the present invention, the POM includes the characteristics of strong intensity, light material, wear resistant, low friction, etc. Consequently, the ratchet wrench with the dust-proof ring 14 made of POM is operated more smoothly than the conventional ratchet wrench with the O-ring for dust-proof. Furthermore, the properties of wear resistant and self-lubricating make the ratchet wrench with the dust-proof ring 14 having a low repair cost and a lone use life. When being used in medical scope, the dust-proof ring 14 provides the properties of anticorrosion such that the ratchet wrench with the dust-proof ring 14 made of POM can be relieved used in the medical scope without worrying about alcohol or other volatile matters. The dust-proof ring 14 in accordance with the present invention bilaterally prevents the dust from entering the ratchet wrench and prevents the lubricant from leaking from the ratchet wrench.

With regard to production of the ratchet wrench in accordance with the present invention, the POM parts are usually formed by injection molding for cost down. However, the mold part may have the statuses of short shot, burr or sink mark due to the injecting pressure, injecting speed, velocity of flow of the melt material or the temperature of the mold, and these statuses may have a bad influence to the dust-proof effect of the dust-proof ring 14. In view of this, the method of the ratchet wrench in accordance with the present invention is related to the property of the material (POM) of the dust-proof ring 14. The POM is previously formed a tube-shaped embryo of the dust-proof ring 14 by injection molding. The tube-shaped embryo is processed (by lathe) to from the dust-proof ring 14 relative to the dimension of the annular groove 13 of the finished shank 10 such that a wrong size should not be occurred to the finished dust-proof ring 14. Even if the tolerance is cumulated, the finished dust-proof ring 14 can also be smoothly assembled into the annular ring 13 because the lathe is completely skillful relative to the current process skill. Furthermore, the dust-proof ring 14, having the statuses of short shot, burr or sink mark, can be screened out for maintaining the dust-proof level of the ratchet wrench in accordance with the present invention.

The method for making the dust-proof ratchet wrench in accordance with the present invention includes the following steps.
1. Previously formed an embryo of the dust-proof ring 14: The POM is previously formed a tube-shaped embryo of the dust-proof ring 14 by injection molding.
2. Processing the shank of the dust-proof ratchet: A through hole 11 is defined in one end of the shank 10, a series of teeth 12 is formed on the inner periphery of the through hole 11 and two annular grooves 13 are respectively defined in two opposite sides of the shank 10, wherein the two annular grooves 13 respectively co-axially correspond to the through hole 11 and the width of the tube-shaped embryo of the dust-proof ring 14 equal to a diameter of a tool for processing the annular groove 13.
3. Finishing the dust-proof ring 14: The tube-shaped embryo of the dust-proof ring 14 is cut to form a ring structure according to the diameter of the annular groove 13 and the diameter of the tool for processing the annular groove 13, wherein the finished dust-proof ring 14 has a thickness slight greater than a depth of the annular groove 13.
4. Assembling: Each annular groove 13 has a dust-proof ring 14 mounted therein. A switch 40, a direction select device 30 and a drive device 20 are sequentially mounted onto the shank 10, wherein a stub 24 extending from the drive device 20 is rotatably engaged into a hole 44 defined in the switch 40 to make the first tray 21 of the drive device 20 and the second tray 41 of the switch 40 respective abut against a corresponding one of the two dust-proof ring 14.

According to the above steps of the method for making the ratchet wrench in accordance with the present invention, the problem of assembling the dust-proof ring of the conventional ratchet wrench due to tolerance cumulated is solved because the dust-proof ring 14 is processed relative to the finished annular groove 13 and the processing accuracy is ensured. The abutments of the dust-proof ring 14 are an accurate faces because they are finished by lathe. As a result, the sink mark formed on the periphery of the embryo of the dust-proof ring 14 does not influence the dust-proof effect of the finished dust-proof ring 14 such that the parts cost of the dust-proof ratchet wrench is reduced.

In addition, the dust-proof ring 14 in accordance with the present invention can be dyed. As a result, the operator can see the color of the dust-proof ring 14 to confirm that the ratchet wrench is a dust-proof ratchet wrench.

As described above, the ratchet wrench with the dust-proof ring 14 made of POM is smoothly operated, has a low repair cost, a long use life, anticorrosion and a small assemble tolerance relative to the conventional dust-proof ratchet wrench with an O-ring.

Although the invention has been explained in relation to its preferred embodiment, it is to be understood that many other possible modifications and variations can be made without departing from the spirit and scope of the invention as hereinafter claimed.

I claim:

1. A method for making a dust-proof ratchet wrench comprising the following steps of:
previously formed an embryo of the dust-proof ring, wherein the POM is previously formed a tube-shaped embryo of the dust-proof ring by injection molding;
processing the shank of the dust-proof ratchet, wherein a through hole is defined in one end of the shank, a series of teeth is formed on the inner periphery of the through hole and two annular grooves are respectively defined in two opposite sides of the shank, the two annular grooves respectively co-axially corresponding to the through hole and the width of the tube-shaped embryo of the dust-proof ring being equal to a diameter of a tool for processing the annular groove;
finishing the dust-proof ring, wherein the tube-shaped embryo of the dust-proof ring is cut to form a ring structure according to the diameter of the annular groove and the diameter of the tool for processing the annular groove, the finished dust-proof ring having a thickness slight greater than a depth of the annular groove; and
assembling, wherein each annular groove has a dust-proof ring mounted therein, a switch, a direction select device and a drive device sequentially mounted onto the shank, wherein a stub, extending from the drive device, is rotatably engaged into a hole defined in the switch to make a first tray of the drive device and a second tray of the switch respective abut against a corresponding one of the two dust-proof ring.
